(19) United States
(12) Patent Application Publication
(10) Pub. No.: US 2009/0172435 A1
(43) Pub. Date: Jul. 2, 2009

(54) METHOD OF MINIMIZING ELECTRIC POWER CONSUMPTION IN NON-BEACON NETWORK

(75) Inventors: Tae-Joon Kang, Gwangmyung-Si (KR); Chan-Hee Jun, Seoul (KR)

Correspondence Address: ARENT FOX LLP, 1050 CONNECTICUT AVENUE, N.W., SUITE 400, WASHINGTON, DC, 20036, US

(73) Assignees: D&S Technology Co., Ltd., Seoul (KR); TaoNetworks Inc., Seoul (KR)

(21) Appl. No.: 12/026,197

(22) Filed: Feb. 5, 2008

(30) Foreign Application Priority Data
Dec. 27, 2007 (KR) 10-2007-0138958

(51) Int. Cl. G06F 1/26

(52) U.S. Cl. 713/320

(57) ABSTRACT

Disclosed herein is a method of minimizing electric power consumption in a non-beacon network including a parent node which maintains an active state only for a specific period in each predetermined cycle, and a child node which attempts to communicate for periods only when data is generated. When data that must be transmitted to the child node exists, the child node notifies the parent node that there is data to be transmitted. The child node periodically transmits the same message to the parent node until the parent node maintains an initial active state. If the parent node is switched into an active state and receives the data transmission notification message, the parent node commands the child node to transmit data. The child node transmits the data to the parent node. Thereafter, the parent node notifies the child node that the reception of data is normally performed.

### BACKGROUND OF THE INVENTION

1. Field of the Invention

The present invention relates generally to a method of constituting an efficient and stable non-beacon network using a small amount of electric power, and, more particularly, to a method of minimizing electric power consumption in a non-beacon network, in which a Full Function Device (FDD), which constitutes a network, does not always maintain an active state but maintains an active state for a predetermined time in each predetermined cycle, thereby minimizing the electric power consumed by the FFD.

2. Description of the Related Art

Generally, a non-beacon network includes two types of nodes. One type of them is a Reduced Function Device (RFD) which mainly performs a function as a sensor and the other type is an FFD which performs a function as a path for communication data. In the non-beacon network, several tens or several hundreds of RFDs are connected to a single FFD so as to constitute a single network. In the network, constituted as described above, the function of such RFD is almost simple. The RFD is in an active state to perform communication only at the moment when the communication is required (chiefly at the moment when a predetermined signal is generated from a sensor embedded in a terminal), and the RFD is in a sleep state during the remaining time, thereby minimizing power consumption. However, the FFD does not know when the RFD, which will communicate with the FFD, attempts to communicate, so that the FFD must maintain an active state. In order to always maintain an active state, as described above, a large amount of electric power should be consumed, so that electric power, supplied from a battery, cannot be used. Accordingly, when a network is constituted, electric power is the most difficult obstacle to be overcome.

Hereinafter, a communication method using a prior art non-beacon network and the problems thereof will be described with reference to attached drawings.

FIG. 1 is a view showing a communication method using a prior art non-beacon network.

Referring to FIG. 1, the FFD and the RFD can respectively function as a parent node and child node.

In a communication process between the parent node and the child node, first, the child node notifies the parent node that there is data to be transmitted, when data that should be transmitted from the child node to the parent node exists at step S1. The parent node, which received the notification, commands the child node to transmit data at step S2. The child node, which received the data transmission command from the parent node, transmits the data to the parent node at step S3. The parent node, which received the data transmitted from the child node, notifies the child node that the reception of data was normally performed at step S4.

The data transmission and reception between the parent node and the child node are performed through the above-described process. In this process, the parent node must always maintain an active state in order to receive a message, which notifies that there is data to be transmitted, from the child node. In contrast, the child node usually maintains a sleep state, and is switched into an active state and processes data transmission only when data that should be transmitted to the parent node exists.

From the viewpoint of the amount of electric power consumption, this will be described with reference to FIG. 2 below.

FIG. 2 is a view showing the amount of electric power consumption in a parent node and a child node when the communication method using the prior art non-beacon network is performed.

Referring to FIG. 2, in the case of the parent node that must always maintain an active state, the amount of electric power consumption always indicates a maximum value.

Meanwhile, in the case of the child node, the amount of electric power consumption indicates a maximum value only when the child node is switched into an active state during data transmission. During the remaining time, the child node is in a sleep state, and the amount of electric power consumption indicates a minimum value. The amount of electric power consumption, consumed in a sleep state, is very small, compared to the amount of electric power consumption, consumed in the active state, so that it can be ignored.

Therefore, the parent node must always maintain an active state, so that a large amount of electric power should be consumed, with the result that electric power supplied from a battery cannot be used. Accordingly, there are problems in that application fields to which a system using a non-beacon network is applied are limited and the cost necessary to construct a system which uses a main electric power is increased.

### SUMMARY OF THE INVENTION

Accordingly, the present invention has been made maintaining in mind the above problems occurring in the prior art, and an object of the present invention is to provide a method of constituting an efficient and stable non-beacon network using a small amount of electric power, and, in particular, to provide a method of minimizing electric power consumption in a non-beacon network, in which an FDD, which constitutes a network, does not always maintain an active state but maintains an active state for a predetermined time in each predetermined cycle, thereby minimizing the electric power consumed by the FFD.

In order to accomplish the above-described object, the present invention provides a method of minimizing electric power consumption in a non-beacon network including a parent node which maintains an active state only for a specific period (t2) in each predetermined cycle (t1), and a child node which attempts to communicate for specific periods (t4) only when data that must be transmitted to the parent node is generated, so that data transmission can be performed while the parent node maintains an initial active state from a moment when data was generated, the method including a first step of the child node, if data that must be transmitted from the child node to the parent node exists, notifying the parent node that there is data to be transmitted; a second step of the child node periodically notifying the parent node that there is data to be transmitted until the parent node maintains the initial active state; a third step of the parent node, if the parent node is switched into an active state and receives a data transmission notification message from the child node, commanding the child node to transmit the data; a fourth step of the child node, which received a data transmission command from the parent node, transmitting the data to the parent node; and a fifth step of the parent node, which received the data transmitted from the child node, notifying the child node that the reception of data is normally performed.

Preferably, setting is made such that the period (t4) has a smaller value than the period (t2), so that, when data that must be transmitted to the child node is generated, data transmission can be performed while the parent node maintains the initial active state from the moment when data was generated.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a view showing a communication method using a prior art non-beacon network;

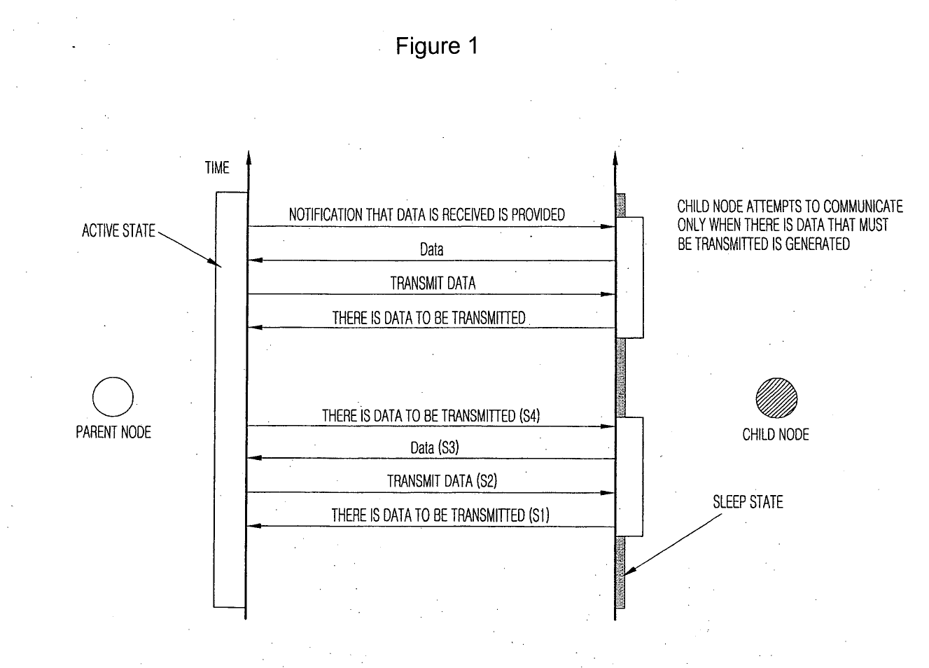

FIG. 2 is a view showing the amount of electric power consumption in a parent node and a child node when the communication method using the prior art non-beacon network is performed;

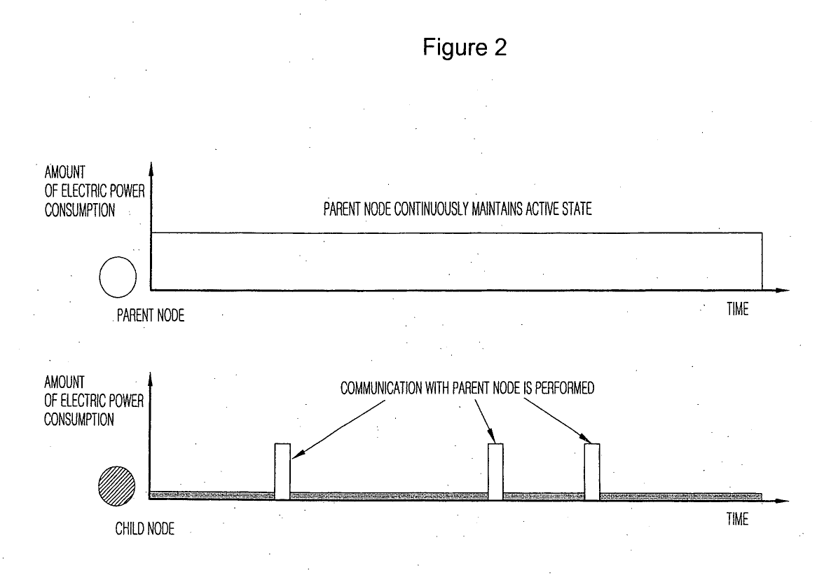

FIG. 3 is a view showing a communication method using a non-beacon network according to the present invention; and

FIG. 4 is a view showing the amount of electric power consumption in a parent node and a child node when the communication method using the non-beacon network according to the present invention is performed.

### DESCRIPTION OF THE PREFERRED EMBODIMENTS

In order to sufficiently understand advantages of the present invention and the operation of the present invention and objects accomplished through the embodiments of the present invention, the accompanying drawings which illustrate the preferred embodiments of the present invention and details described in the accompanying drawings should be referred to.

Hereinafter, the present invention will be described in detail by describing preferred embodiments of the present invention with reference to the attached drawings. The same reference numerals, which are used throughout the different drawings, designate the same or similar components.

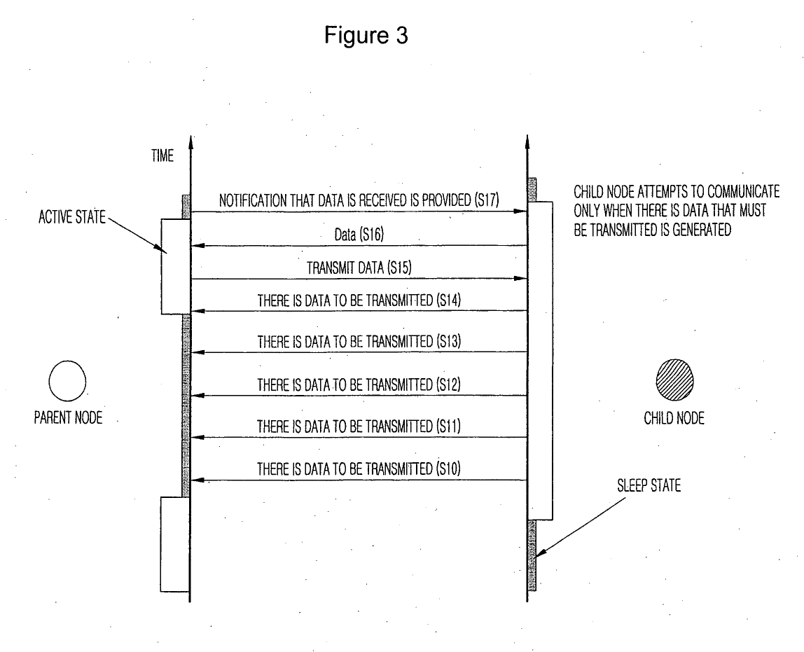

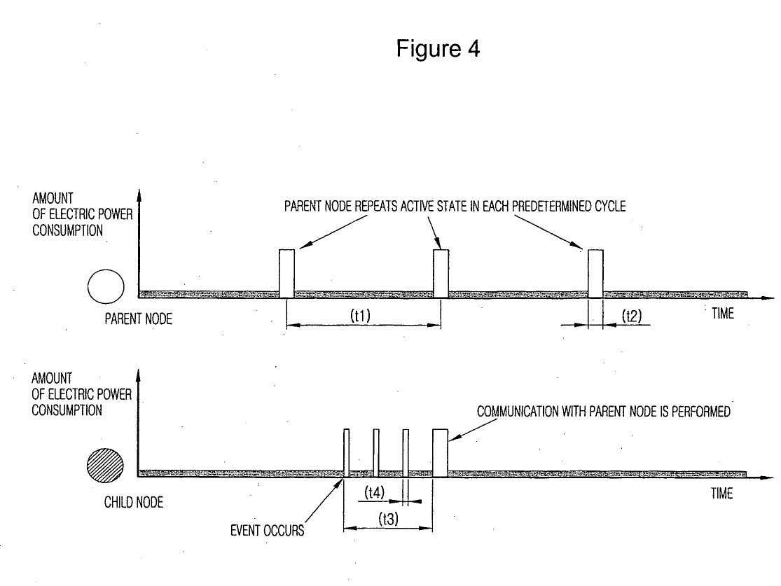

FIG. 3 is a view showing a communication method using a non-beacon network according to the present invention, and FIG. 4 is a view showing the amount of electric power consumption in a parent node and a child node when the communication method using a non-beacon network according to the present invention is performed.

Referring to FIGS. 3 and 4, an FFD and an RFD can respectively function as a parent node and a child node.

The parent node maintains an active state only for a specific period ‘t2 ’ in each predetermined cycle ‘t1’.

Meanwhile, the child node attempts to communicate for periods ‘t4 ’ in a predetermined period ‘t3 ’ only when data that must be transmitted to the parent node is generated.

Setting is made such that the period ‘t4 ’ has a smaller value than the period ‘t2 ’, so that, when data that must be transmitted to the child node is generated, data transmission can be performed while the parent node maintains an initial active state from the moment when data was generated.

In the communication process between the parent node and the child node, first, when data that must be transmitted to the child node exists, the child node notifies the parent node that there is data to be transmitted at step S10. However, a data transmission notification message cannot be transmitted when the parent node is at a sleep state, so that the child node periodically transmits the same message to the parent node at step S11 to S14. During these steps, if the parent node is switched into an active state and receives the data transmission notification message from the child node, the parent node commands the child node to transmit data at step S15. The child node, which received the data transmission command from the parent node, transmits the data to the parent node at step S16. The parent node, which received data transmitted from the child node, notifies the child node that the reception of data is normally performed at step S17.

For example, the parent nod maintains an active state only for 0.1 second in each 10 seconds cycle. When an event occurs, that is, communication should be performed, the child node attempts to communicate for periods, that is, 0.09 seconds, until the parent node maintains the active state.

The amount of electric power consumption, consumed in a sleep state, is very small, compared to the amount of electric power consumption, consumed in the active state, so that it can be ignored. If a system is configured as described above, the amount of electric power consumption consumed by the parent node becomes one-hundredth, compared to a prior art method.

Although it is not actually impossible, if it is assumed that the parent node is driven using a battery in the prior art non-beacon network and the duration thereof is 10 days, the duration of the parent node in a non-beacon network according to the proposed method can be maintained for a time corresponding to 1000 days.

Of course, when the event of data transmission occurs in the child node, a data transmission notification message must be periodically transmitted until the parent node maintains an active state. Therefore, the amount of electric power consumption may be increased. However, basically, it is assumed that the operation of the child node is generated at extremely low frequency, so that the electric power consumption can be ignored.

As described above, the present invention provides a method of constituting an efficient and stable non-beacon network using a small amount of electric power. In particular, the present invention provides a method of minimizing electric power consumption in a non-beacon network, in which an FDD, which constitutes a network, does not always maintain an active state but maintains an active state for a predetermined time in each predetermined cycle, thereby minimizing the electric power consumed by the FFD.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of minimizing electric power consumption in a non-beacon network including a parent node which maintains an active state only for a specific period (t2) in each predetermined cycle (t1), and a child node which attempts to communicate for specific periods (t4) only when data that must be transmitted to the parent node is generated, so that data transmission can be performed while the parent node maintains an initial active state from a moment when data was generated, the method comprising:
a first step of the child node, if data that must be transmitted from the child node to the parent node exists, notifying the parent node that there is data to be transmitted;
a second step of the child node periodically notifying the parent node that there is data to be transmitted until the parent node maintains the initial active state;
a third step of the parent node, if the parent node is switched into an active state and receives a data transmission notification message from the child node, commanding the child node to transmit the data;
a fourth step of the child node, which received a data transmission command from the parent node, transmitting the data to the parent node; and
a fifth step of the parent node, which received the data transmitted from the child node, notifying the child node that reception of data is normally performed.

2. The method as set forth in claim 1, wherein setting is made such that the period (t4) has a smaller value than the period (t2), so that, when data that must be transmitted to the child node is generated, data transmission can be performed while the parent node maintains the initial active state from the moment when data was generated.
